(19) United States
(12) Patent Application Publication
(10) Pub. No.: US 2012/0005710 A1
(43) Pub. Date: Jan. 5, 2012

(54) Program Search Apparatus and Program Search Method

(76) Inventors: Masatoshi Murakami, Hamura-shi (JP); Mitsunori Omokawa, Ageo-shi (JP); Hiroyuki Kamio, Tachikawa-shi (JP); Hiroshi Kazawa, Kumagaya-shi (JP); Yuuki Nemoto, Kokubunji-shi (JP); Takayuki Tachikawa, Fukaya-shi (JP); Megumi Miyazaki, Kumagaya-shi (JP)

(21) Appl. No.: 13/109,622

(22) Filed: May 17, 2011

(30) Foreign Application Priority Data
Jun. 30, 2010 (JP) 2010-150035

(51) Int. Cl. H04N 5/445

(52) U.S. Cl. 725/53

(57) ABSTRACT

According to one embodiment, a program search apparatus includes a communication module, a search module, and an output controller. The communication module is configured to communicate with an external apparatus via a network. The search module is configured to search for a corresponding program corresponding to a designated program designated from a program table via the network. The output controller is configured to execute control to output a search result.

### CROSS-REFERENCE TO RELATED APPLICATIONS

This application is based upon and claims the benefit of priority from prior Japanese Patent Application No. 2010-150035, filed Jun. 30, 2010, the entire contents of which are incorporated herein by reference.

### FIELD

Embodiments described herein relate generally to a program search apparatus and program search method.

### BACKGROUND

In recent years, television broadcast receivers, which can receive a digital television broadcast signal, and can record and play back a program based on the received digital television broadcast signal, have become common. For example, the television broadcast receiver acquires service data from a digital television broadcast signal, and can execute control to display a program table based on this service data. On the program table, a plurality of broadcast programs corresponding to a plurality of channels are displayed along a channel axis and time axis. Such program table is called an electronic program guide (EPG). The television broadcast receiver accepts a recording reservation of a program selected from the program table, and can record the selected program using an HDD, DVD, or Blu-ray® Disc (BD).

As described above, the user can know broadcast-scheduled programs via the program table displayed by the television broadcast receiver. However, the user cannot view a broadcast-scheduled program before broadcasting, and he or she cannot view it even after broadcasting when video recording of the broadcast-scheduled program has failed. That is, the viewing opportunity of a broadcast program is not sufficient.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing the arrangement of a video recording/playback apparatus (program search apparatus) common to the first to third embodiments;

FIG. 2 is a table showing an example of search target Web sites;

FIG. 3 is a flowchart showing an example of processes from display of a program table until that of an archive site;

FIG. 4 is a flowchart showing an example of the archive site display processing;

FIG. 5 is a flowchart showing an example of the archive site display processing in response to a designation of a recording failure program;

FIG. 6 is a flowchart showing an example of list registration processing of a recording failure program;

FIG. 7 is a view showing an example of a program table;

FIG. 8 is a flowchart showing an example of display or registration processing of an archive site;

FIG. 9 is a view showing an example of a program recording reservation screen;

FIG. 10 is a view showing an example of a site display confirmation screen;

FIG. 11 is a view showing a display example of a viewing site; and

FIG. 12 is a view showing a display example of a recording list.

### DETAILED DESCRIPTION

Various embodiments will be described hereinafter with reference to the accompanying drawings.

In general, according to one embodiment, a program search apparatus includes a communication module, a search module, and an output controller. The communication module is configured to communicate with an external apparatus via a network. The search module is configured to search for a corresponding program corresponding to a designated program designated from a program table via the network. The output controller is configured to execute control to output a search result.

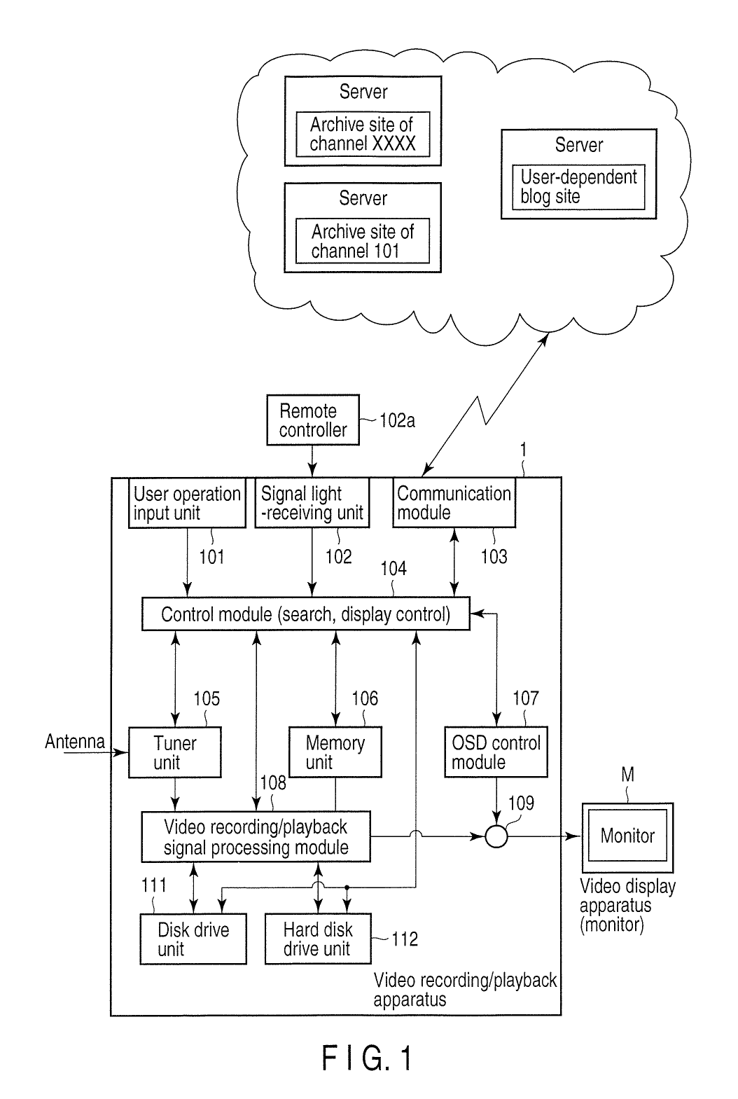

FIG. 1 is a schematic block diagram showing the arrangement of a video recording/playback apparatus (program search apparatus) common to the first to third embodiments. The first to third embodiments will explain program search processing by the video recording/playback apparatus. However, the present invention is not limited to the program search processing by the video recording/playback apparatus. For example, the program search processing to be described in the first to third embodiments is also applicable to a television broadcast receiver (digital TV) including a program recording function.

As shown in FIG. 1, a video recording/playback apparatus 1 includes a user operation input unit 101, signal light-receiving unit 102, communication module 103, control module (controller) 104, tuner unit 105, memory unit 106, OSD control module 107, recording/playback signal processing module 108, composition processing module 109, disk drive unit 111, and hard disk drive unit 112.

The control module 104 can control a program recording operation and playback operation, and can control execution of program search processing (to be described later). The communication module 103 can establish connections with, for example, various servers, can transmit various kinds of data to these servers, and can receive various kinds of data from these servers.

The tuner unit 105 selects a broadcast signal of a designated channel, and inputs the selected broadcast signal to the recording/playback signal processing module 108. When recording processing is designated, the recording/playback signal processing module 108 inputs program content (video and audio signals) corresponding to the broadcast signal to the disk drive unit 111 or hard disk drive unit 112. The disk drive unit 111 records the input program content on an optical disk such as a DVD or Blu-ray® Disk (BD). Or the hard disk drive unit 112 records the input program content on a hard disk. When playback processing is designated, the recording/playback signal processing module 108 outputs the program content corresponding to the broadcast signal to a video display apparatus M (digital TV) including loudspeakers and the like via the composition processing module 109.

Examples of various operations via a remote controller 102a will be described below. Various operations via the user operation input unit 101 are substantially the same as those via the remote controller 102a, and a description thereof will not be given.

The remote controller 102a has a plurality of keys, and transmits instructions input via these keys. The signal light-receiving unit 102 receives instructions from the remote controller 102a and notifies the control module 104 of the received instructions. For example, when the remote controller 102a transmits a program table display instruction, the control module 104 receives the program table display instruction, and executes control to display a program table.

For example, the video recording/playback apparatus 1 can acquire program table data required to display the program table from a broadcast signal input to the tuner unit 105. The video recording/playback apparatus 1 can also acquire program table data via a network and the communication module 103. The memory unit 106 stores the acquired program table data. The control module 104 generates a program table based on the stored program table data, and outputs it to the OSD control module 107. The OSD control module 107 outputs the program table to the composition processing module 109. The composition processing module 109 can output only a video picture of the program table, can output a video picture obtained by superimposing a video picture of the program table on that of a predetermined program, and can output both a video picture of the predetermined program and that of the program table under the control of the OSD control module 107. In this way, the video display apparatus M displays the program table.

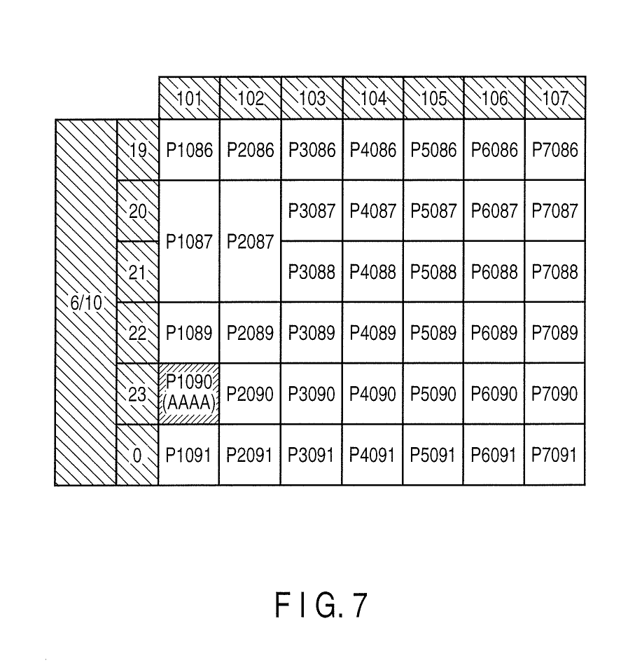

FIG. 7 is a view showing a display example of the program table. As shown in FIG. 7, the program table displays a plurality of broadcast programs (P1086 to P1091, P2086 to P2091, P3086 to P3091, P4086 to P4091, P5086 to P5091, P6086 to P6091, and P7086 to P7091) corresponding to a plurality of channels (for example, channels 101 to 107) along a channel axis (for example, that of the channels 101 to 107) and a time axis (for example, that of 19:00 to 0:00).

Program search processing by the video recording/playback apparatus 1 will be described below.

### First Embodiment

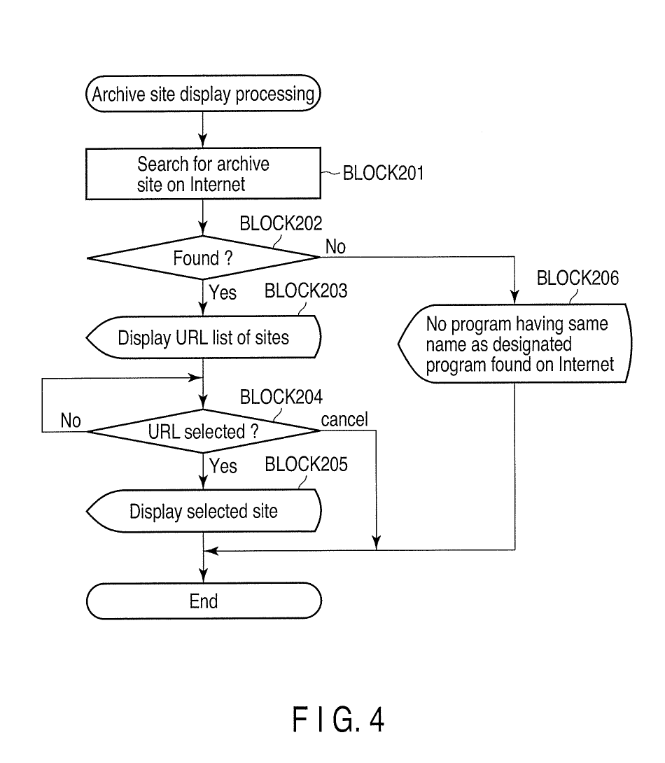

For example, the video recording/playback apparatus 1 can search for a corresponding program, which corresponds to a designated program designated on the program table, and can output a search result. The corresponding program is a program including substantially the same content as the designated program (that including the same content). For example, the designated program is a predetermined drama program which is to be normally broadcast, and the corresponding program is a predetermined drama program which is not broadcast (the corresponding program is the predetermined drama program which allows streaming or download playback). Also, the designated program is a predetermined drama program including a main title and commercials, and the corresponding program is a predetermined drama program which includes a main title but does not include any commercials. Also, for example, the image quality of the designated program need not always be the same as that of the corresponding program. An example of display processing of an archive site (library site) which can access the corresponding program will be described below with reference to the flowcharts shown in FIGS. 3 and 4.

For example, the user can issue a display instruction of the program table shown in FIG. 7 via the remote controller 102a, and can also designate a program as a recording or viewing reservation target from the displayed program table (YES in BLOCK 101).

In response to this designation, for example, the control module 104 extracts search key data such as a program name, program ID (event ID), broadcast start date and time, and broadcast end date and time from metadata of the designated program (BLOCK 102). Furthermore, the control module 104 searches for a corresponding program (for example, a program substantially the same as the designated program) corresponding to the designated program based on the search key data. For example, the control module 104 searches one or a plurality of search target Web sites (for example, movie viewing sites) for the corresponding program via the communication module 103.

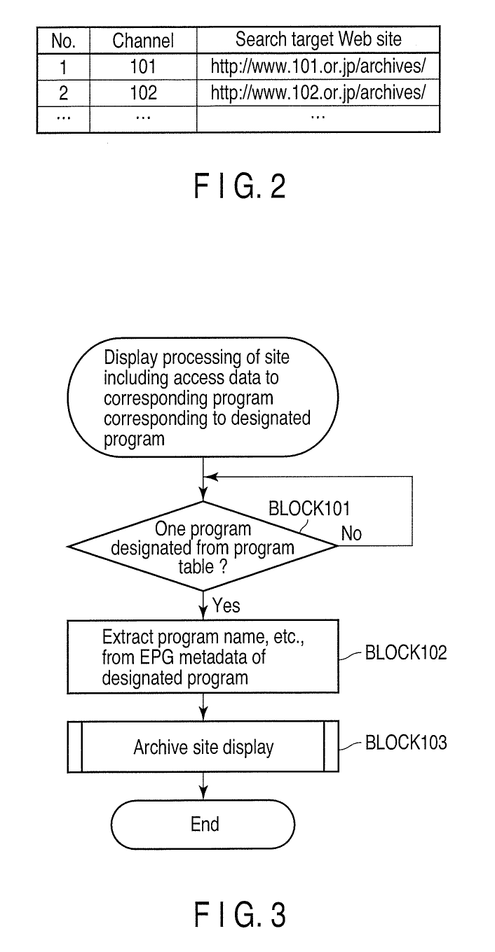

The memory unit 106 can store addresses of the search target Web sites. For example, as shown in FIG. 2, the memory unit 106 can store the addresses of Web sites corresponding to receivable channels. The control module 104 can search a Web site (that managed by a server of a broadcast station which broadcasts the channel 101) of the search targets for the corresponding program based on the address stored in the memory unit 106 in response to the designation of the program of the channel 101. Or the control module 104 can search all the search target Web sites for the corresponding program based on the addresses stored in the memory unit 106 in response to the designation of the program of the channel 101.

With the aforementioned processing, for example, when an archive site managed by the broadcast station which broadcasts the channel 101 exists, and when this archive site stores the program corresponding to the designated program, the control module 104 can execute control to output access data required to access the corresponding program managed by this archive site. As a result, for example, the video display apparatus M can display the archive site including the aforementioned access data (BLOCK 103).

The archive site can also be displayed, as shown in the flowchart of FIG. 4. For example, the control module 104 searches for archive sites which allow the user to access the corresponding program via the Internet (BLOCK 201). If one or a plurality of archive sites are found (YES in BLOCK 202), the control module 104 executes control to display a URL list of the one or plurality of found archive sites. In response to this, the video display apparatus M displays the URL list of the one or the plurality of found archive sites (BLOCK 203).

The user can select a desired URL from the URL list of the one or plurality of archive sites via the remote controller 102a. If the user selects the desired URL (YES in BLOCK 204), the control module 104 executes control to access the selected URL, and to display the archive site of the selected URL. In response to this, the video display apparatus M displays the archive site of the selected URL (BLOCK 205).

Note that if no archive site including the access data is found (NO in BLOCK 202), the control module 104 executes control to display data indicating that no archive site is found. In response to this, the video display apparatus M displays the data indicating that no archive site is found (BLOCK 206).

The display processing of archive sites has been exemplified. However, the video recording/playback apparatus 1 can also display blog sites (introductory sites) in place of the archive sites, or can also display both the archive sites and blog sites.

A data providing function of recorded programs of the video recording/playback apparatus 1 will be described below. This data providing function allows a blog site that provides information about the designated program (corresponding program) to be displayed. The memory unit 106 of the video recording/playback apparatus 1 stores a recording list (video recording list) including data on recorded programs (program names and so forth). The control module 104 can upload recorded program data via the communication module 103. For example, the control module 104 can upload the recorded program data to a user-dependent blog site (a user-dependent blog site managed by an external server) managed by a manufacturer of the video recording/playback apparatus 1 via the communication module 103. For example, one blog site is assigned in correspondence with one video recording/playback apparatus 1 (an ID of one video recording/playback apparatus 1). Then, items of recorded program data provided from a plurality of video recording/playback apparatuses 1 are uploaded to a plurality of blog sites. Also, the external server can distribute addresses of the plurality of blog sites to the respective video recording/playback apparatuses 1. In response to this, the memory unit 106 of each video recording/playback apparatus 1 can store the addresses of the plurality of blog sites. Hence, the control module 104 can search the plurality of blog sites for a blog site that provides information about the designated program based on the addresses of the plurality of blog sites stored in the memory unit 106 in response to the designation of the program of the channel 101.

A blog site that provides information about the designated program may be searched for as follows. For example, the memory unit 106 of the video recording apparatus stores an address of an external server that manages blog sites. The communication module 103 transmits search key data corresponding to the designated program to the external server (the address of the external server). The external server searches a plurality of blog sites for a blog site that provides information about the designated program based on the search key data, and notifies the video recording apparatus of an address of the blog site that provides information about the designated program. The control module 104 of the video recording apparatus executes control to display the blog site based on the address of the blog site that provides information about the designated program. In response to this, the video display apparatus M can display the blog site that provides information about the designated program. Alternatively, the external server may store addresses of blog sites according to respective video recording apparatuses in substitution for storage of the address of the external server by the memory unit 106.

As described above, the video recording/playback apparatus 1 can display (introduce) an archive site that allows the user to view a corresponding program corresponding to the designated program designated on the program table. For example, when the user selects a program P1089 (title AAAA) of the channel 101 on the program table, a streaming site of title AAAA of an archive site of the channel 101 on the Internet can be displayed.

Also, the video recording/playback apparatus 1 can display (introduce) a blog site that provides information about the designated program designated on the program table. For example, when the user selects a program P1089 (title AAAA) of the channel 101 on the program table, a blog site that provides information about title AAAA on the Internet can be displayed.

Note that the video recording/playback apparatus 1 can display an archive site that allows the user to view a corresponding program corresponding to the designated program designated on the program table, and can also display a blog site that provides information about the designated program.

The video recording/playback apparatus 1 can search a search target archive site designated in advance for the corresponding program. For example, an archive site (that managed by the broadcast station which broadcasts the channel 101) corresponding to the channel (for example, the channel 101) of the designated program can be designated as a search target. As a result, the search efficiency can be improved. Likewise, the video recording/playback apparatus 1 can search a search target blog site designated in advance for data about the designated program. Then, the search efficiency can be improved.

### Second Embodiment

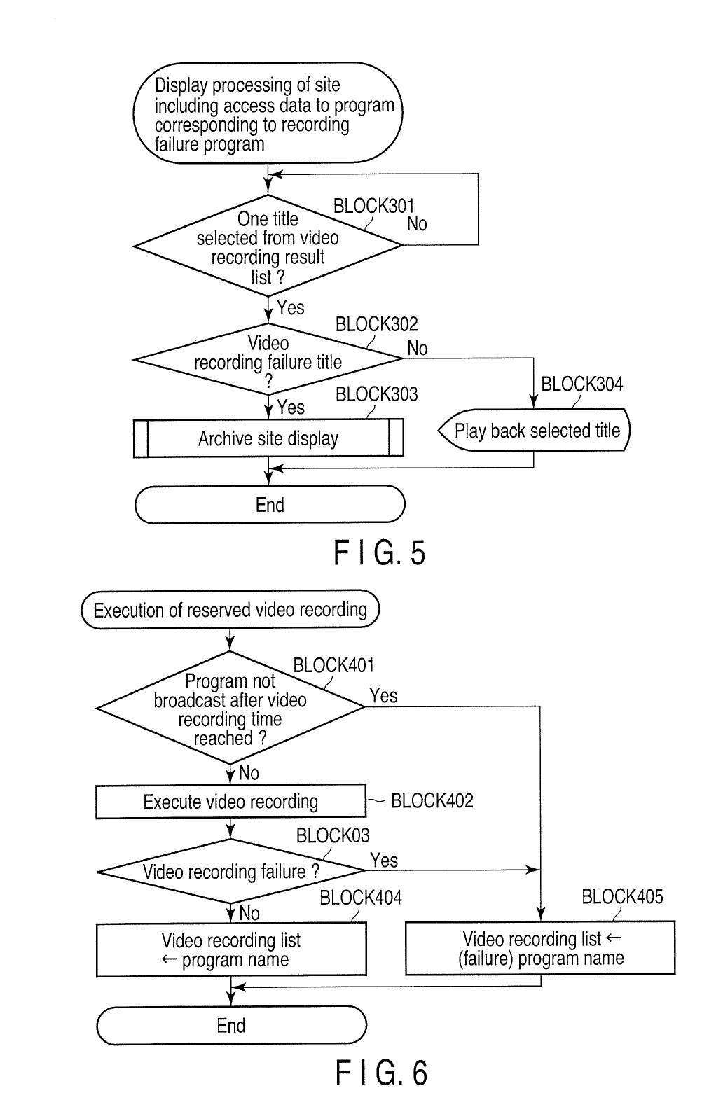

For example, the video recording/playback apparatus 1 can search for a corresponding program, which corresponds to a recording designated program designated as a recording target on the program table and to a recording failure program whose recording has failed, and can output a search result. An example of display processing of an archive site that allows the user to access a program corresponding to a recording failure program will be described below with reference to the flowcharts of FIGS. 5 and 6.

For example, the user can issue a display instruction of the program table shown in FIG. 7 via the remote controller 102a, and can designate a program as a recording reservation target from the displayed program table. The control module 104 registers the designated program as the recording reservation target in a recording reservation list (video recording reservation list), and executes control to record the designated program based on the recording reservation list. With this recording control, the tuner 105 selects a broadcast signal of the designated program at a predetermined timing, and the recording/playback signal processing module 108 outputs the designated program to the disk drive unit 111 or hard disk drive unit 112. In response to this, the disk drive unit 111 or hard disk drive unit 112 records the designated program.

For example, as shown in FIG. 6, if the designated program begins to be broadcast at a broadcast start time of the designated program registered in the recording reservation list (NO in BLOCK 401), the control module 104 executes control to record the designated program, and the disk drive unit 111 or hard disk drive unit 112 records the designated program in response to this control (BLOCK 402). If the designated program is normally recorded (NO in BLOCK 403), the control module 104 registers a program name of the designated program in a recording list (BLOCK 404).

For example, if the designated program does not begin to be broadcast at the broadcast start time of the designated program registered in the recording reservation list (YES in BLOCK 401), or if the designated program is not normally recorded (YES in BLOCK 403), the control module 104 appends data indicating a recording failure to the program name of the designated program, and registers the program name appended with the recording failure data in the recording list (BLOCK 404).

That is, in the recording list, the program name which is normally recorded and that which is not normally recorded (that appended with the recording failure data) are registered. The user can issue a display instruction of the recording list via the remote controller 102a, and can designate one program name from the displayed recording list.

Alternatively, as described above, the control module 104 can upload the recording list (including the program name which is normally recorded and that which is not normally recorded) to a blog site via the communication module 103. Thus, the user can issue a display instruction of the recording list on the blog site via the remote controller 102a, and can designate one program name from the recording list on the blog site.

For example, as shown in FIG. 5, if the user designates the program name on the recording list (YES in BLOCK 301) and the designated program name is that which is normally recorded (NO in BLOCK 302), the control module 104 executes control to play back the designated program corresponding to the designated program name. That is, in response to this, the disk drive unit 111 or hard disk drive unit 112 plays back the designated program (BLOCK 304).

If the designated program name is that which is not normally recorded (YES in BLOCK 302), the control module 104 extracts search key data such as a program name, program ID (event ID), broadcast start date and time, and broadcast end date and time from metadata of the designated program. Furthermore, the control module 104 searches for a corresponding program (for example, a program substantially the same as the designated program) corresponding to the designated program based on the search key data. For example, the control module 104 searches one or a plurality of search target Web sites (for example, movie viewing sites) for the corresponding program via the communication module 103.

The memory unit 106 can store addresses of the search target Web sites. The control module 104 can search a Web site corresponding to the channel 101 of the search targets for the corresponding program based on the address stored in the memory unit 106 in response to the designation of the program of the channel 101. Or the control module 104 can search all the search target Web sites for the corresponding program based on the addresses stored in the memory unit 106 in response to the designation of the program of the channel 101.

With the aforementioned processing, for example, when an archive site managed by the broadcast station which broadcasts the channel 101 exists, and when this archive site stores the corresponding program corresponding to the designated program, the control module 104 can execute control to output access data required to access the corresponding program managed by this archive site. As a result, for example, the video display apparatus M can display the archive site including the aforementioned access data (BLOCK 303).

The display processing of archive sites has been exemplified. However, the video recording/playback apparatus 1 can also display blog sites (introductory sites) in place of the archive sites, or can also display both the archive sites and blog sites.

The data providing function described in the first embodiment allows a blog site that provides information about the designated program (corresponding program) to be displayed. For example, the control module 104 can search a plurality of blog sites for a blog site that provides information about the designated program based on the addresses of the plurality of blog sites stored in the memory unit 106 in response to the designation of the program (recording failure program) of the channel 101.

With the above processing, the video recording/playback apparatus 1 can display (introduce) an archive site that allows the user to view a program corresponding to the designated program (recording failure program) designated on the recording list. Or the video recording/playback apparatus 1 can also display a URL list of one or a plurality of archive sites which allow the user to view a program corresponding to the designated program (recording failure program) designated on the recording list. Also, the video recording/playback apparatus 1 can display (introduce) a blog site that provides information about the designated program (recording failure program) designated on the recording list. Or the video recording/playback apparatus 1 can also display a URL list of one or a plurality of blog sites that provide information about the designated program (recording failure program) designated on the recording list.

Note that the video recording/playback apparatus 1 can display an archive site that allows the user to view a corresponding program corresponding to the designated program (recording failure program) designated on the recording list, and can also display a blog site that provides information about the designated program (recording failure program).

Also, the video recording/playback apparatus 1 can search a search target archive site designated in advance for a corresponding program (recording failure program). Likewise, the video recording/playback apparatus 1 can search a search target blog site designated in advance for data about the designated program (recording failure program). Thus, the search efficiency can be improved.

Note that the video recording/playback apparatus 1 can notify the user of an archive site that allows the user to view a corresponding program corresponding to the designated program (recording failure program) via a mail message. For example, the user can register a mail address in the memory unit 106 via the remote controller 102a. The control module 104 executes control to transmit the URL of an archive site to the registered mail address, and the communication module 103 transmits the URL of the archive site to the registered mail address. Likewise, the video recording/playback apparatus 1 can notify the user of a blog site that provides information about the designated program (recording failure program) via a mail message.

### Third Embodiment

For example, the video recording/playback apparatus 1 can search for a program corresponding to a designated program designated on the program table. When the search for the corresponding program has succeeded, the video recording/playback apparatus 1 allows to display an archive site (viewing site) accessible to the corresponding program or to select a recording reservation of the designated program.

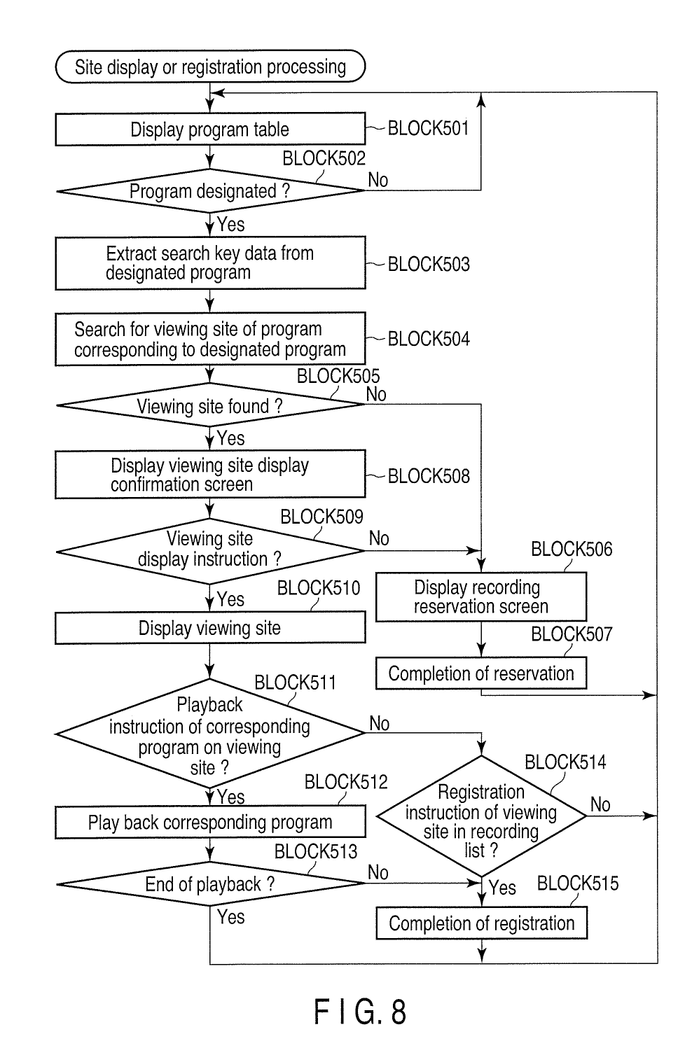

As shown in FIG. 8, for example, the user can issue a display instruction of the program table shown in FIG. 7 via the remote controller 102a, and the video display apparatus M displays the program table in response to this instruction (BLOCK 501). Furthermore, the user can designate a program from the displayed program table via the remote controller 102a (YES in BLOCK 502).

In response to this designation, for example, the control module 104 extracts search key data such as a program name, program ID (event ID), broadcast start date and time, and broadcast end date and time from metadata of the designated program (BLOCK 503). Furthermore, the control module 104 searches for a program (for example, a program substantially the same as the designated program) corresponding to the designated program based on the search key data (BLOCK 504). For example, the control module 104 searches one or a plurality of search target Web sites (for example, movie viewing sites) for a viewing site of the corresponding program via the communication module 103.

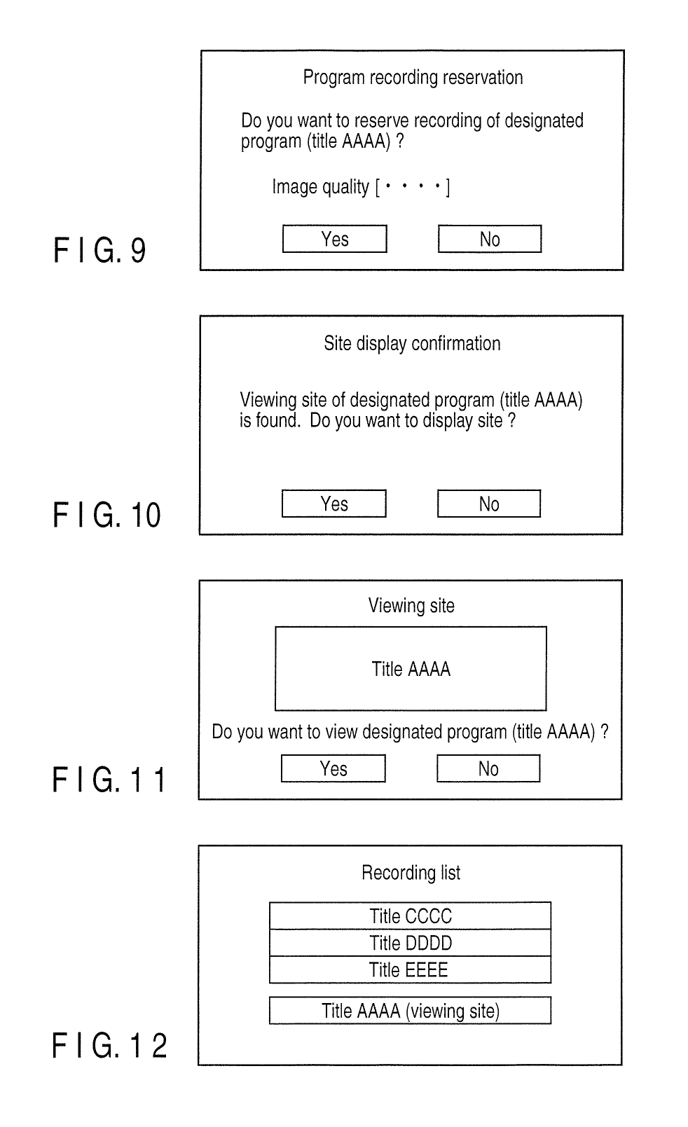

If no viewing site of the corresponding program is found (NO in BLOCK 505), the control module 104 executes control to display a recording reservation screen. Then, for example, the video display apparatus M displays a recording reservation screen shown in FIG. 9 (BLOCK 506). If the user selects execution of recording reservation from the recording reservation screen via the remote controller 102a, the control module 104 registers the designated program in a recording reservation list (BLOCK 507), and executes control to display the program table again. Then, the video display apparatus M displays the program table (BLOCK 501).

If a viewing site of the corresponding program is found (YES in BLOCK 505), the control module 104 executes control to display a viewing site display confirmation screen including access data required to access the corresponding program. Then, for example, the video display apparatus M displays a viewing site display confirmation screen shown in FIG. 10 (BLOCK 508). The viewing site display confirmation screen guides that a viewing site of the designated program (corresponding program) is found.

If the user issues a display instruction of the viewing site via the remote controller 102a (YES in BLOCK 509), the control module 104 executes control to display the viewing site. Then, the video display apparatus M displays the viewing site of the corresponding program, as shown in FIG. 11 (BLOCK 510).

If the user selects viewing of the designated program (corresponding program) from the viewing site via the remote controller 102a (YES in BLOCK 511), the control module 104 issues a playback request of the corresponding program via the communication module 103 and receives playback data of the corresponding program. In response to this, the control module 104 executes control to play back the received playback data (BLOCK 512), and the video display apparatus M displays a video picture based on the playback data. If the playback of the received playback data is complete (YES in BLOCK 513), the control module 104 executes control to display the program table again. Then, the video display apparatus M displays the program table (BLOCK 501).

If the user selects list registration of the viewing site of the corresponding program via the remote controller 102a while the viewing site of the corresponding program is displayed (YES in BLOCK 514), for example, the control module 104 registers a URL of the viewing site of the corresponding program in a recording list (or playback list) (BLOCK 515). Thus, for example, the URL of the viewing site of the corresponding program is registered in the recording list (or playback list) together with the recorded program name. Note that the URL of the viewing site of the corresponding program may be registered by replacing it by the program name of the designated program. Upon completion of registration of the viewing site, the control module 104 executes control to display the program table again. Then, the video display apparatus M displays the program table (BLOCK 501). Or if the user issues a cancel instruction of the list registration of the viewing site of the corresponding program via the remote controller 102a while the viewing site of the corresponding program is displayed (NO in BLOCK 514), the control module 104 executes control to display the program table again. Then, the video display apparatus M displays the program table (BLOCK 501).

As described above, if the user issues a recording list display instruction via the remote controller 102a after completion of registration of the viewing site, the control module 104 executes control to display the recording list, and the video display apparatus M displays the recorded program name and the URL of the viewing site of the designated program (or the program name of the designated program), which are registered in the recording list (see FIG. 12). If the user selects the URL of the viewing site of the designated program (or the program name of the designated program) via the remote controller 102a, the control module 104 executes control to access the viewing site based on the URL of the viewing site of the designated program. Then, the video display apparatus M can display the viewing site of the designated program.

As described above, the video recording/playback apparatus 1 can reserve recording of the program designated on the program table, and can display the viewing site that allows the user to view the program corresponding to the designated program. That is, when the viewing site of the program corresponding to the designated program whose recording is to be reserved exists, the video recording/playback apparatus 1 allows the user to view the corresponding program before recording of the designated program is completed. The video recording/playback apparatus 1 can also register the viewing site of the corresponding program in the recording list. Thus, the user can select the viewing site of the corresponding program and can view the corresponding program on the viewing site by the same operation feeling as that when he or she selects the program name of the recorded program name in the recording list.

Effects of the first to third embodiments will be summarized below.

The video recording/playback apparatus 1 of the first or third embodiment allows the user to easily view a corresponding program corresponding to the designated program without waiting for broadcasting of the designated program.

The video recording/playback apparatus 1 of the second embodiment can quickly search for the designated program even when the designated program cannot be recorded.

Furthermore, the video recording/playback apparatus 1 of the third embodiment can register the viewing site in, for example, the recording list, and the user can view the corresponding program on the viewing site by the same operation feeling as that when he or she selects the recorded program name in the recording list.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program search apparatus comprising:
a communication module configured to communicate with an external apparatus via a network;
a search module configured to search for a corresponding program corresponding to a designated program designated from a program table via the network; and
an output controller configured to execute control to output a search result.

2. The apparatus of claim 1, wherein the output controller is configured to execute control to output guide data indicating that the corresponding program exists.

3. The apparatus of claim 1, wherein the output controller is configured to execute control to output access data required to access the corresponding program.

4. The apparatus of claim 1, wherein the output controller is configured to execute control to output a movie viewing site including access data required to access the corresponding program.

5. The apparatus of claim 3, further comprising:
a registration unit configured to register the access data.

6. The apparatus of claim 5, wherein the registration unit is configured to manage a playback list, and to register the access data in the playback list, and
the output controller is configured to execute control to output the playback list.

7. The apparatus of claim 1, wherein the search module is configured to search a designated search target site for the corresponding program.

8. The apparatus of claim 1, wherein the search module is configured to search for the corresponding program in response to a recording failure of the designated program.

9. The apparatus of claim 1, wherein the search module is configured to search for an introductory site including data about the designated program.

10. A program search method comprising:
searching for a corresponding program corresponding to a designated program designated from a program table via a network; and
controlling to output a search result.

11. The method of claim 10, wherein the corresponding program includes a program having substantially the same content as the designated program.
